(19) United States
(12) Patent Application Publication
(10) Pub. No.: US 2026/0028259 A1
(43) Pub. Date: Jan. 29, 2026

(54) POWDERED ACTIVATED CARBON (PAC) ENHANCED ACTIVATED SLUDGE SYSTEM FOR REMOVING PER- AND POLYFLUOROALKYL SUBSTANCES (PFAS) FROM A FLOW OF WASTEWATER AND/OR LANDFILL LEACHATE

(71) Applicant: Emerging Compounds Treatment Technologies, Inc., North Little Rock, AR (US)

(72) Inventors: Paul Rodriguez, Scarborough, ME (US); Steven E. Woodard, Cumberland, ME (US); David Kempisty, Colorado Springs, CO (US)

(21) Appl. No.: 18/781,383

(22) Filed: Jul. 23, 2024

(51) Int. Cl. C02F 3/12; C02F 101/36; C02F 103/06

(52) U.S. Cl. CPC C02F 3/1226; C02F 2101/36; C02F 2103/06

(57) ABSTRACT

A powdered activated carbon (PAC) enhanced activated sludge system for removing PFAS from a flow of wastewater and/or landfill leachate includes at least one bioreactor including biomass to receive the flow wastewater and/or landfill leachate and to promote growth of biological flocs and an impregnation subsystem which receives a flow of biomass and/or settled biomass and a predetermined amount PAC and blends the biomass and/or the settled biomass with the PAC to form PAC-impregnated biological flocs. The at least one impregnation system outputs a flow of PAC-impregnated biological flocs to the bioreactor such that the PAC-impregnated biological flocs in the bioreactor adsorb to and remove a majority of the PFAS from the flow of wastewater and/or landfill leachate and the bioreactor outputs a flow of PAC-impregnated biological flocs having a majority of the PFAS adsorbed thereto and wastewater and/or landfill leachate having a majority of the PFAS removed. The system also includes at least one secondary clarifier coupled to the bioreactor which separates the PAC-impregnated biological flocs having a majority of the PFAS adsorbed thereto from the wastewater and/or landfill leachate having a majority of the PFAS removed and produces a flow the treated wastewater and/or landfill leachate having a majority of the PFAS removed.

### APPLICATION FOR UNITED STATES LETTERS PATENT

Be it known that we, Paul Rodriguez, residing at 258 Holmes Road, Scarborough, ME 04074 and being a citizen of the United States; Steven E. Woodard, residing at 17 Homestead Lane, Cumberland, ME 04021 and being a citizen of the United States; and David Kempisty, residing at 965 Flying Eagle Place, Colorado Springs, CO 80919 and being a citizen of the United States, have invented a certain new and useful A POWDERED ACTIVATED CARBON (PAC) ENHANCED ACTIVATED SLUDGE SYSTEM FOR REMOVING PER-AND POLYFLUOROALKYL SUBSTANCES (PFAS) FROM A FLOW OF WASTEWATER AND/OR LANDFILL LEACHATE of which the following is a specification:

### FIELD OF THE INVENTION

This invention relates to a powdered activated carbon (PAC) enhanced activated sludge system or removing per- and polyfluoroalkyl substances (PFAS) from a flow of wastewater and/or landfill leachate.

### BACKGROUND OF THE INVENTION

Municipal and industrial wastewater treatment facilities are used to treat wastewater and/or landfill leachate to remove contaminants, such as suspended solids, biodegradable organics, phosphorus, nitrogen, microbiological contaminants, and the like, to provide a clean effluent. The clean effluent is typically subject to strict local, state and federal regulations.

Activated sludge is one type of biological treatment process which utilizes a bioreactor(s) that contains a large population of microorganisms, the “biomass,” that consume contaminants from a flow of wastewater and/or landfill leachate to form biological “flocs.” Air may be delivered into the bioreactor(s) to provide dissolved oxygen and promote growth of these biological flocs. The mixture of wastewater and/or landfill leachate, biomass, and dissolved oxygen is commonly known as mixed liquor. The population or concentration of microorganisms in the mixed liquor is often referred to as mixed liquor suspended solids (MLSS).

After sufficient treatment in the bioreactor(s), the mixed liquor is then typically sent to a secondary clarifier where the biological flocs are separated by gravity from the mixed liquor to provide a secondary effluent and a settled sludge. The secondary effluent, or “clean” effluent, may be discharged back to the environment or processed by additional tertiary treatment processes. The majority of the settled sludge in the secondary clarifier is typically recycled back to the bioreactor by a return activated sludge subsystem. As disclosed herein, a majority is greater than about 50%. The remaining, excess sludge may be wasted from the system to control the concentration of mixed liquor suspended solids.

Per- and polyfluoroalkyl substances (PFAS) are a class of man-made compounds that have been used to manufacture consumer products and industrial chemicals, including, inter alia, aqueous film forming foams (AFFFs). AFFFs have been the product of choice for firefighting at military and municipal fire training sites around the world. AFFFs have also been used extensively at oil and gas refineries for both fire training and firefighting exercises. AFFFs work by blanketing spilled oil/fuel, cooling the surface, and preventing re-ignition. PFAS in AFFFs have contaminated the groundwater, surface water, and wastewater and/or landfill leachate at many of these sites and refineries, including more than 100 U.S. Air Force bases.

PFAS may be used as surface treatment/coatings in consumer products such as carpets, upholstery, stain resistant apparel, cookware, paper, packaging, and the like, and may also be found in chemicals used for chemical plating, electrolytes, lubricants, and the like, which may eventually end up in the water supply.

PFAS are bio-accumulative in wildlife and humans because they typically remain in the body for extended periods of time. Laboratory PFAS exposure studies on animals have shown problems with growth and development, reproduction, and liver damage. In April 2024, the U.S. Environmental Protection Agency (EPA) issued the following strict maximum contaminant levels (MCLs) for six PFAS compounds: PFOA, PFOS, GenX, PFNA PFHxS and PFBS. Additionally, PFAS are highly soluble in water in large, dilute groundwater plumes, and have a low volatility.

PFAS are very difficult to treat largely because they are extremely stable compounds which include carbon-fluorine bonds. Carbon-fluorine bonds are the strongest known covalent bonds in nature and are highly resistant to breakdown and therefore not considered decomposable.

Conventional powdered activated carbon (PAC) may also be used to remove PFAS from wastewater and/or landfill leachate.

To date, conventional wastewater treatment facilities which utilize a bioreactor(s) and a secondary clarifier(s) have not been used to remove PFAS from a flow of wastewater or landfill leachate because the majority of PFAS pass through the bioreactor and secondary clarifier untreated. As discussed above, PFAS are highly resistant to breakdown and therefore do not biodegrade to an appreciable degree in the bioreactor.

Thus, there is a need for a modified activated sludge system that optimizes the particle size of the PAC and impregnates PAC into the biological flocs to effectively and efficiently remove PFAS from a flow of wastewater or landfill leachate, and reduces the overall operational cost of the system and method thereof.

### SUMMARY OF THE INVENTION

In one aspect, a powdered activated carbon (PAC) enhanced activated sludge system for removing PFAS from a flow of wastewater and/or landfill leachate is featured. The system includes at least one bioreactor including biomass to receive the flow wastewater and/or landfill leachate and to promote growth of biological flocs, and an impregnation subsystem which receives a flow of biomass and a predetermined amount of PAC and blends the biomass and/or settled biomass with the PAC to form PAC-impregnated biological flocs. The at least one impregnation subsystem outputs a flow of PAC-impregnated biological flocs to the bioreactor such that the PAC-impregnated biological flocs in the bioreactor adsorb to and remove a majority of the PFAS from the flow of wastewater and/or landfill leachate and the bioreactor outputs a flow of PAC-impregnated biological flocs having a majority of the PFAS adsorbed thereto and wastewater and/or landfill leachate having a majority of the PFAS removed. The system also includes at least one secondary clarifier coupled to the bioreactor(s) which separates the PAC-impregnated biological flocs having a majority of the PFAS adsorbed thereto from the wastewater and/or landfill leachate having a majority of the PFAS removed and produces a flow the treated wastewater and/or landfill leachate having a majority of the PFAS removed.

In one example, at least one of the secondary clarifier or the bioreactor may be configured to output a waste flow of PAC-impregnated biological flocs having PFAS adsorbed thereto. The waste flow of PAC-impregnated floc having PFAS adsorbed thereto may set to control a biological population of microorganisms in bioreactor. The waste flow of PAC-impregnated biological flocs having PFAS adsorbed thereto may be used to create a waste product. The waste product may be directed to at least one of: a supercritical water oxidation (SCWO) subsystem or a plasma gasification subsystem configured to destroy the waste product, including the PAC-impregnated biological flocs and the PFAS adsorbed thereto. The impregnation subsystem may include at least one impregnation confinement area and at least one mixer. The impregnation confinement area may include at least one of: an impregnation tank or a baffed section in the bioreactor. The at least one impregnation confinement area may be sized and configured to augment PAC impregnation into the biological flocs. The blending intensity in the impregnation confinement area may be configured to augment PAC impregnation into the biological flocs. The flow of biomass to the impregnation subsystem may be from at least one of: the bioreactor or the secondary clarifier. The PAC-impregnated biological flocs enhance secondary clarification. The average size of the PAC may be less than about 600 microns. The impregnation subsystem may blend the biomass with the PAC and/or settled biomass 44 using mixing energy in the range of about 100 sec⁻¹ to about 5,000 sec⁻¹.

In another aspect, a powdered activated carbon (PAC) enhanced activated sludge method for removing PFAS from a flow of wastewater and/or landfill leachate is featured. The method includes receiving the flow wastewater and/or landfill leachate and promoting growth of biological flocs in a bioreactor, receiving a flow of biomass and/or settled biomass and a predetermined amount of PAC, blending the biomass and/or the settled biomass with the PAC to form PAC-impregnated biological flocs, outputting a flow of PAC-impregnated biological flocs to the bioreactor such that the PAC-impregnated biological flocs in the bioreactor adsorb to and remove a majority of the PFAS from the flow of wastewater and/or landfill leachate, outputting a flow of PAC-impregnated biological flocs having a majority of the PFAS adsorbed thereto and wastewater and/or landfill leachate having a majority of the PFAS removed, separating the PAC-impregnated biological flocs having a majority of the PFAS adsorbed thereto from the wastewater and/or landfill leachate having a majority of the PFAS removed, and producing a flow the treated wastewater and/or landfill leachate having a majority of the PFAS removed.

In one example, the method may include outputting a waste flow of PAC-impregnated biological flocs having PFAS adsorbed thereto. The waste flow of PAC-impregnated biological flocs having PFAS adsorbed thereto may be set to control a biological population of microorganisms in the bioreactor. The waste flow of PAC-impregnated biological flocs having PFAS adsorbed thereto may be used to create a waste product. The waste product may be directed to at least one of: a supercritical water oxidation (SCWO) process or a plasma gasification subsystem configured to destroy the waste product including the PAC-impregnated biological flocs and the PFAS adsorbed thereto. The flow of biomass may from at least one of: the bioreactor or a secondary clarifier. The PAC-impregnated biological flocs may enhance secondary clarification. The PAC may be less than about 600 microns. The biomass and/or the settled biomass may be blended with PAC using mixing energy in the range of about 100 sec⁻¹ to about 5,000 sec⁻¹.

### BRIEF DESCRIPTION OF THE SEVERAL VIEWS OF THE DRAWINGS

Other objects, features and advantages will occur to those skilled in the art from the following description of a preferred embodiment and the accompanying drawings, in which:

FIG. 1 is a schematic block diagram showing the primary components of one example of the PAC enhanced activated sludge system for removing PFAS from a flow of wastewater and/or landfill leachate;

FIG. 2 shows in further detail examples of PAC-impregnated biological flocs;

FIGS. 3A, 3B, and 3C are microscopic photographs showing examples of PAC-impregnated biological flocs; and

FIG. 4 is a is a flow chart showing the primary components of one example of the PAC enhanced activated sludge method for removing PFAS from a flow of wastewater and/or landfill leachate.

### DETAILED DESCRIPTION OF THE INVENTION

Aside from the preferred embodiment or embodiments disclosed below, this invention is capable of other embodiments and of being practiced or being carried out in various ways. Thus, it is to be understood that the invention is not limited in its application to the details of construction and the arrangements of components set forth in the following description or illustrated in the drawings. If only one embodiment is described herein, the claims hereof are not to be limited to that embodiment. Moreover, the claims hereof are not to be read restrictively unless there is clear and convincing evidence manifesting a certain exclusion, restriction, or disclaimer.

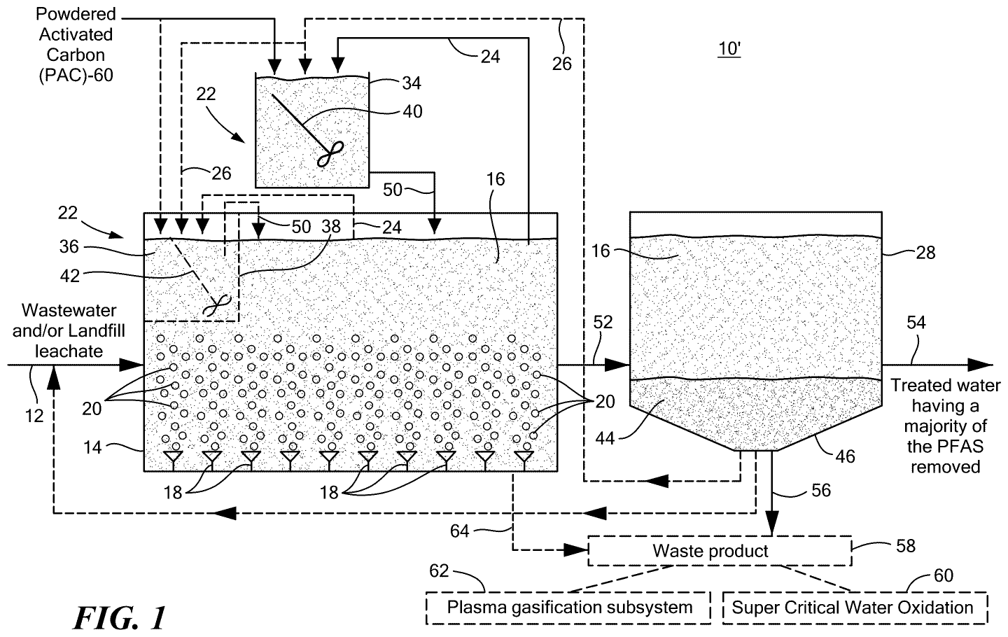

There is shown in FIG. 1, one example powdered activated carbon (PAC) enhanced activated sludge system 10 for removing PFAS from a flow of wastewater and/or landfill leachate includes at least one bioreactor 14 which includes biomass therein, e.g., microorganisms, such as bacteria, protozoa, and the like, exemplarily indicated at 16, which promotes growth of biological flocs in biomass 16. Bioreactor 14 preferably includes diffuser subsystem 18 which preferably receives ambient air and injects dissolved oxygen, exemplarily indicated at 20, into bioreactor 14 to promote the growth of biological flocs.

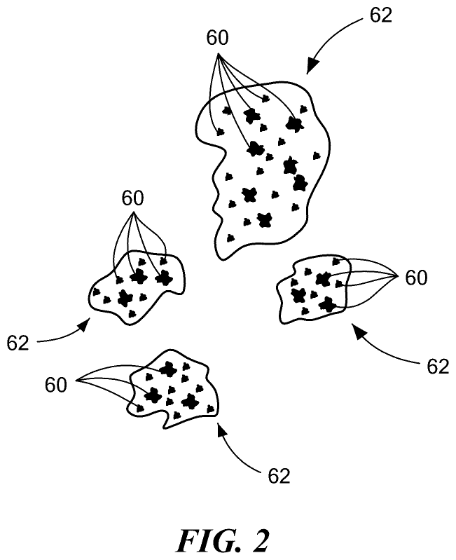

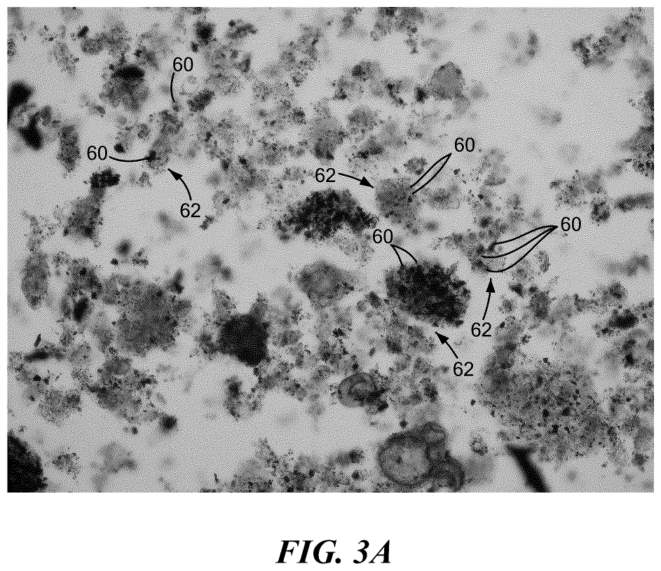

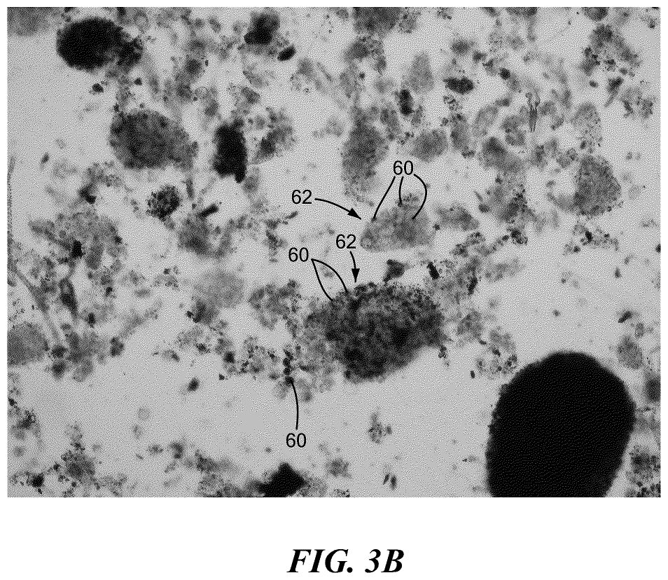

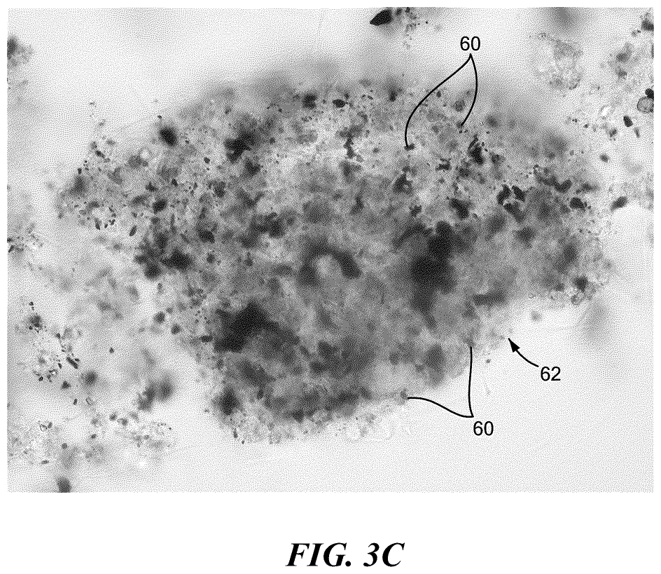

System 10 includes impregnation subsystem 22 which receives a flow 24, FIG. 1, of biomass 16 from bioreactor 14 and/or flow 26 of settled biomass 44 from secondary clarifier 28 and a predetermined amount powdered activated carbon (PAC) 60. Impregnation subsystem 22 blends biomass 16 and/or settled biomass 44 with the PAC 60 to form PAC-impregnated biological flocs, exemplarily indicated at 62, FIG. 2, in bioreactor 14. FIGS. 3A and 3B depict microscopic photographs showing in further detail examples of PAC-impregnated biological flocs 62 with PAC 60 therein as shown. FIG. 3C is an enlarged microscopic photograph showing in further detail a single PAC-impregnated biological floc 62 with PAC 60 therein.

In this example, the impregnation confinement area, e.g., impregnation tank 34 or confinement area 36 defined by baffle 38 in bioreactor 14, is preferably sized and configured to augment the impregnation of PAC 60 into the biological flocs. Preferably a blending intensity in the impregnation confinement area, discussed below, augments the formation of PAC-impregnated biological flocs 62.

Impregnation subsystem 22 blends biomass 16 and/or settled biomass 44 with PAC 60, preferably under high shear conditions or mixing energy (velocity gradient), e.g., about 100 sec⁻¹ to about 5,000 sec⁻¹ or preferably about 500 sec⁻¹ to about 1,000 sec⁻¹ or similar type mixing energy, to form PAC-impregnated biological flocs 62. In one example, the average size of PAC 60 is preferably less than about 600 microns. In another example, the average size of PAC 60 may be less than about 100 microns. In yet another example, the average size of PAC 60 may be less than about 50 microns.

In one example, impregnation subsystem 22 may receive flow 24 of biomass from bioreactor 14 as shown. In another example, impregnation subsystem 22 may receive flow 26 of settled biomass 44 from secondary clarifier 28 as shown. Flow 24 of biomass 16 may include, inter alia, a flow of a mixed liquor (a mixture of wastewater and/or landfill leachate, biomass 16, water, and dissolved oxygen). Flow 26 of biomass 16 may include, inter alia, a flow of a mixed liquor (a mixture of wastewater and/or landfill leachate, biomass 16, water, and dissolved oxygen), and settled or thickened sludge 44 located at bottom 46 of secondary clarifier 28 having PAC-impregnated biological flocs with PFAS adsorbed thereto.

Impregnation subsystem 22 outputs flow 50 of PAC-impregnated biological flocs 62 to bioreactor 14 such that the PAC-impregnated biological flocs 62 in bioreactor 14 adsorb to and remove a majority of the PFAS from flow 12 of wastewater and/or landfill leachate. As disclosed herein, a majority is greater than about 50%. Bioreactor 14 outputs flow 52 of PAC-impregnated biological flocs 62 having a majority of the PFAS adsorbed thereto and wastewater and/or landfill leachate having a majority of the PFAS removed.

PAC-impregnated biological flocs 62 provided by impregnation subsystem 22 preferably maintain PAC-impregnated biological flocs 62 in suspension throughout bioreactor 14. This preferably maximizes contact of PFAS in flow 12 of wastewater and/or landfill leachate with PAC-impregnated biological flocs 62 such that a majority of the PFAS in flow 12 adsorbs to PAC-impregnated biological flocs 62.

In this example, at least one secondary clarifier 28 preferably separates the PAC-impregnated biological flocs 62 having a majority of the PFAS adsorbed thereto from the wastewater and/or landfill leachate having a majority of the PFAS removed and produces flow 54 of treated wastewater and/or landfill leachate having a majority of the PFAS removed.

Secondary clarifier 28 separates PAC-impregnated biological flocs 62 having a majority of the PFAS adsorbed thereto from the wastewater and/or landfill leachate having the majority of PFAS removed by allowing PAC-impregnated biological flocs 62 having a majority of the PFAS adsorbed thereto to settle and collect at bottom 46 of secondary clarifier 28 and form settled sludge 44 as shown.

The result is system 10 preferably optimizes the particle size of PAC 60 and/or the mixing energy to impregnate PAC 60 into the biological flocs to form PAC-impregnated biological flocs 62 to effectively and efficiently remove PFAS from a flow of wastewater or landfill leachate.

In one example, secondary clarifier 28 preferably outputs waste flow 56 of PAC-impregnated biological flocs 62 having PFAS adsorbed thereto. Waste flow 56 may be set to control a biological population of microorganisms in biomass 16 in bioreactor 14. Waste flow 56 may also preferably be used to create waste product 58. Waste product 58 preferably includes at least PAC-impregnated biological flocs 62 and the PFAS adsorbed thereto. In one example, waste product 58, which may be directed to supercritical water oxidation (SCWO) process 60 and/or plasma gasification subsystem 62, or similar type PFAS destruction subsystems, to preferably destroy waste product 58 including the PAC-impregnated biological flocs 62 and the PFAS adsorbed thereto.

Similarly, bioreactor 14 may output waste flow 64 of PAC-impregnated biological flocs 62 having PFAS adsorbed thereto. Waste flow 64 may be set to control a biological population of microorganisms in biomass 16 in bioreactor 14. Waste flow 64 may also preferably be used to create waste product 58 preferably including at least the PAC-impregnated biological flocs 62 and the PFAS adsorbed thereto. In one example, waste product 58 may be directed to supercritical water oxidation (SCWO) process 60 and/or plasma gasification subsystem 62, or similar type PFAS destruction subsystems, to preferably destroy waste product 58, including the PAC-impregnated biological flocs 62 and the PFAS adsorbed thereto.

In one example, PAC-impregnated biological flocs 62 preferably increase treatment kinetics thereby reducing the required hydraulic retention time and size of bioreactor 14.

PAC-impregnated biological flocs 62 preferably enhance secondary clarification in secondary clarifier 28. This is because the PAC-impregnated biological flocs 62 preferably have higher specific gravity than biomass 16, PAC-impregnated biological flocs 62 preferably settle faster, and PAC-impregnated biological flocs 62 preferably remove color or other non-biodegradable and/or slowly biodegradable compounds from the wastewater and/or landfill leachate.

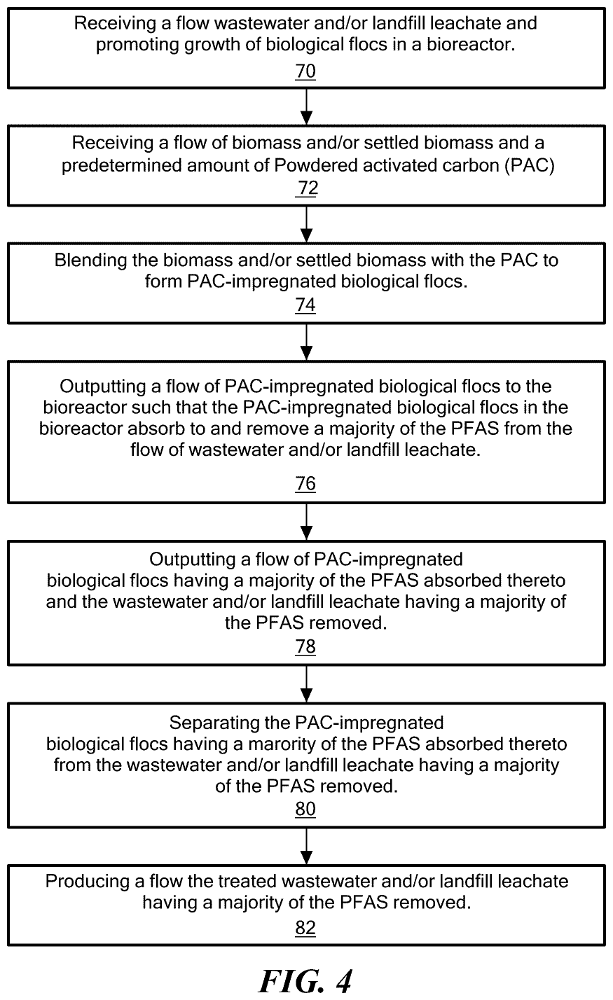

One example of the powdered activated carbon (PAC) enhanced activated sludge method for removing PFAS from a flow of wastewater and/or landfill leachate preferably includes receiving the flow of wastewater and/or landfill leachate and to promote growth of biological flocs in a bioreactor, step 70, FIG. 4, receiving a flow of biomass and/or settled biomass and a predetermined amount of PAC, step 72, blending the biomass and/or settled biomass with the PAC to form PAC-impregnated biological flocs, step 74, and outputting a flow of PAC-impregnated biological flocs to the bioreactor such that the PAC-impregnated biological flocs in the bioreactor adsorb to and remove a majority of the PFAS from the flow of wastewater and/or landfill leachate, step 76. The method also includes outputting a flow of PAC-impregnated biological flocs having a majority of the PFAS adsorbed thereto and wastewater and/or landfill leachate having a majority of the PFAS removed, step 78, separating the PAC-impregnated biological flocs having a majority of the PFAS adsorbed thereto from the wastewater and/or landfill leachate having a majority of the PFAS removed, step 80, and producing a flow the treated wastewater and/or landfill leachate having a majority of the PFAS removed, step 82.

Although specific features of the invention are shown in some drawings and not in others, this is for convenience only as each feature may be combined with any or all of the other features in accordance with the invention. The words “including”, “comprising”, “having”, and “with” as used herein are to be interpreted broadly and comprehensively and are not limited to any physical interconnection. Moreover, any embodiments disclosed in the subject application are not to be taken as the only possible embodiments. Other embodiments will occur to those skilled in the art and are within the following claims.

In addition, any amendment presented during the prosecution of the patent application for this patent is not a disclaimer of any claim element presented in the application as filed: those skilled in the art cannot reasonably be expected to draft a claim that would literally encompass all possible equivalents, many equivalents will be unforeseeable at the time of the amendment and are beyond a fair interpretation of what is to be surrendered (if anything), the rationale underlying the amendment may bear no more than a tangential relation to many equivalents, and/or there are many other reasons the applicant cannot be expected to describe certain insubstantial substitutes for any claim element amended.

What is claimed is:

1. A powdered activated carbon (PAC) enhanced activated sludge system for removing per- and polyfluoroalkyl substances (PFAS) from a flow of wastewater and/or landfill leachate, the system comprising:
at least one bioreactor including biomass to receive the flow wastewater and/or landfill leachate and to promote growth of biological flocs;
an impregnation subsystem to receive a flow of biomass and/or settled biomass and a predetermined amount PAC and to blend the biomass and/or the settled biomass with the PAC to form PAC-impregnated biological flocs;
the at least one impregnation system outputs a flow of PAC-impregnated biological flocs to the bioreactor such that the PAC-impregnated biological flocs in the bioreactor adsorb to and remove a majority of the PFAS from the flow of wastewater and/or landfill leachate and the bioreactor outputs a flow of PAC-impregnated biological flocs having a majority of the PFAS adsorbed thereto and wastewater and/or landfill leachate having a majority of the PFAS removed;
at least one secondary clarifier coupled to the bioreactor to separate the PAC-impregnated biological flocs having a majority of the PFAS adsorbed thereto from the wastewater and/or landfill leachate having a majority of the PFAS removed and produce a flow the treated wastewater and/or landfill leachate having a majority of the PFAS removed.

2. The system of claim 1 in which at least one of the secondary clarifier or the bioreactor is configured to output a waste flow of PAC-impregnated biological flocs having PFAS adsorbed thereto.

3. The system of claim 2 in which the waste flow of PAC-impregnated flocs having PFAS adsorbed thereto is set to control a biological population of microorganisms in the bioreactor.

4. The system of claim 2 in which the waste flow of PAC-impregnated biological flocs having PFAS adsorbed thereto is used to create a waste product.

5. The system of claim 4 in which the waste product is directed to at least one of: a supercritical water oxidation (SCWO) process or a plasma gasification subsystem configured to destroy the waste product including the PAC-impregnated biological flocs and the PFAS adsorbed thereto.

6. The system of claim 1 in which the impregnation subsystem includes at least one impregnation confinement area and at least one mixer.

7. The system of claim 6 in which the impregnation confinement area includes at least one of: an impregnation tank or a baffed section in the bioreactor.

8. The system of claim 7 in which the at least one impregnation confinement area is sized and configured to augment PAC impregnation into the biological flocs.

9. The system of claim 6 in which blending intensity in the impregnation confinement area is configured to augment PAC impregnation into the biological flocs.

10. The system of claim 1 in which the flow of biomass to the impregnation subsystem is from at least one of: the bioreactor or the secondary clarifier.

11. The system of claim 1 in which the PAC-impregnated biological flocs enhance secondary clarification.

12. The system of claim 1 in which the average size of the PAC is less than about 600 microns.

13. The system of claim 1 in which the impregnation subsystem blends the biomass and/or the settled biomass with the PAC using mixing energy in the range of about 100 sec⁻¹ to about 5,000 sec⁻¹.

14. A powdered activated carbon (PAC) enhanced activated sludge method for removing per- and polyfluoroalkyl substances (PFAS) from a flow of wastewater and/or landfill leachate, the method comprising:
receiving the flow wastewater and/or landfill leachate and promoting growth of biological flocs in a bioreactor;
receiving a flow of biomass and/or settled biomass and a predetermined amount of PAC;
blending the biomass and/or the settled biomass with the PAC to form PAC-impregnated biological flocs;
outputting a flow of PAC-impregnated biological flocs to the bioreactor such that the PAC-impregnated biological flocs in the bioreactor adsorb to and remove a majority of the PFAS from the flow of wastewater and/or landfill leachate
outputting a flow of PAC-impregnated biological flocs having a majority of the PFAS adsorbed thereto and wastewater and/or landfill leachate having a majority of the PFAS removed;
separating the PAC-impregnated biological flocs having a majority of the PFAS adsorbed thereto from the wastewater and/or landfill leachate having a majority of the PFAS removed; and
producing a flow the treated wastewater and/or landfill leachate having a majority of the PFAS removed.

15. The method of claim 14 including outputting a waste flow of PAC-impregnated biological flocs having PFAS adsorbed thereto.

16. The method of claim 15 in which the waste flow of PAC-impregnated biological flocs having PFAS adsorbed thereto is set to control a biological population of microorganisms in the bioreactor.

17. The method of claim 15 in which the waste flow of PAC-impregnated biological flocs having PFAS adsorbed thereto is used to create a waste product.

18. The method of claim 17 in which the waste product is directed to at least one of: a supercritical water oxidation (SCWO) process or a plasma gasification subsystem configured to destroy the waste product including the PAC-impregnated biological flocs and the PFAS adsorbed thereto.

19. The method of claim 14 in which the flow of biomass is from at least one of: the bioreactor or a secondary clarifier.

20. The method of claim 14 in which the PAC-impregnated biological flocs enhance secondary clarification.

21. The method of claim 14 in which the average size of the PAC is less than about 600 microns.

22. The method of claim 14 in which the biomass and/or the settled biomass is blended with PAC using mixing energy in the range of about 100 sec⁻¹ to about 5,000 sec⁻¹.
